(19) United States
(12) Patent Application Publication
(10) Pub. No.: US 2010/0250589 A1
(43) Pub. Date: Sep. 30, 2010

(54) Tree structured P2P overlay database system

(75) Inventor: Wei Kang Tsai, Irvine, CA (US)

Correspondence Address: Wei Kang Tsai, 8 Young Court, Irvine, CA, 92617, US

(73) Assignee: Grasstell Networks LLC

(21) Appl. No.: 12/383,726

(22) Filed: Mar. 26, 2009

(51) Int. Cl. G06F 7/06; G06F 17/30

(52) U.S. Cl. 707/770; 707/E17.032

(57) ABSTRACT

A system and methods to construct and maintain a balanced-tree overlay network are used to host distributed databases. As overlay nodes can detach from and re-attach to an overlay unpredictably, overlay protocols must maintain the overlay tree properly to minimize communication overheads associated with store and retrieval operations of the hosted databases. Unlike a DHT (distributed hash table) approach, the balanced-tree approach has the advantages of stabilizibility and provable correctness of the overlay protocols. Fast inquiry can be achieved by using a caching algorithm that allows each overlay node to keep track of data ranges stored in a neighboring set of nodes. Self-healing and load balancing protocols are also incorporated to enhance the performance and stability of the tree-structured overlay.

### CROSS REFERENCE TO RELATED APPLICATION

This application claims the benefit of U.S. Provisional Patent Application Ser. No. 61/070,118, filed Mar. 20, 2008, the disclosure of which is herein expressly incorporated by reference.

### FIELD OF THE INVENTION

The present invention relates in general, to retrieval of data from a distributed database, and more particularly, to retrieval of data from a database hosed on an overlay network of volatile distributed nodes.

### BACKGROUND OF THE INVENTION

The problem addressed by the present invention is to efficiently retrieve data items based on keys from a distributed database. The entirety of the database records, each comprising of a key and an associated data item, are stored in distributed nodes located across different geographical and network domains.

There exist numerous applications for such abstract technical problem. A prominent application is Internet search engine that has become an integral part of modern life.

Another application is electronic yellow page. In this application, a business may advertise its goods and services on an online yellow page service to connect customers to vendors through locate proper communications.

A more refined context of the present invention is that of data retrieval from a distributed P2P (peer-to-peer) overlay network. Among P2P overlay systems, there are two types: structured and unstructured. Most of the deployed P2P overlays are unstructured, for example, the BitTorrent system.

The present invention focuses on structured P2P overlay systems. Many such systems are designed for applications that employ SIP as the application layer protocol. For such overlays, the search technology is commonly known as P2P SIP or overlay SIP; its main use is to store and retrieve IP addresses based on SIP identifiers over distributed nodes. There are numerous applications supported by SIP overlays; prominent ones include voice or video (VoIP) over IP. Hereafter, both voice-over-IP and video-over-IP will be referred to as VoIP.

For P2P SIP applications, keys are often SIP identifiers for individual users, which are usually unique by design. Uniqueness of identifiers is a separate issue from the present invention. The present invention concerns with correct retrieval of data with keys, independent of uniqueness of keys. In case keys are non-unique, the method of the present invention will produce all the data associated with the same key; thus uniqueness of keys does not impact the utilities of the present invention at all. Therefore, keys are assumed to be unique for the present invention.

A common feature for overlay applications is that an overlay node that stores data may disappear (stop participating) for unpredictably. It is in this sense that nodes are said to be volatile or perishable. For the present invention, all overlay nodes are assumed to be volatile in that they can detach from or attached to an overlay completely unpredictably. Therefore, an important design criterion for such overlay systems is to retrieve data as fast as possible in spite of network dynamics and uncertainties.

Therefore, an object of the present invention is to minimize the time for an inquiry to retrieve data while minimizing communication overheads in the overlay to maintain data coherency.

As in most distributed database systems, there are two main components in the design: data structures to store the distributed data, and protocols to maintain coherency, and to store and retrieve data. It should be noted that there are two types of data structure. The first one, which can be properly called distributed data structure, deals with the entirety of the data stored in the overlay. The second one, which can be properly called the node data structure, deals with the way data are stored in individual nodes in the overlay. Protocols used to maintain database coherency, and to retrieve and store data will be referred to as overlay protocols.

In most if not all P2P SIP overlay systems, the distributed data structure used is a ring, as exemplified by the popular Chord overlay system. Ring is used because the overlay protocol is based on implementing a distributed hashing table (DHT) over the overlay, and a hashing function maps keys into a linear 1-D (1-dimensional) space, or integers. A ring is topologically equivalent to a 1-D linear space.

In the present invention, the 1-D linear space is mapped into a balanced tree.

The distinguishing feature of the present invention is that it uses a tree-structured overlay to make the overlay system less susceptible to dynamics and uncertainties. If fact, the ring-structured overlay in most P2P SIP system is a root cause of instability and excessive overheads. It has been shown that dynamics may cause a ring-structured overlay to enter into cyclical states such that it is impossible to retrieve certain data. Therefore, corrective actions need to be taken to overcome this impairment. The correctness of overlay protocols for ring-structured overlay is difficult to prove due to this cyclical problem. In fact, no rigorous stability proof has been obtained so far.

In a tree-structured overlay system by the present invention, no cyclical states will result at any time. However, it is still possible that certain parts of the overlay may become unreachable, possibly caused by overlay dynamics. Since a tree topology is more structured, the corrective actions needed are simpler and the correctness of the overlay protocol is much easier to prove.

The ability to deal with uncertainties and dynamics in an overlay system will be referred to as the stabilizibility of the overlay system. Thus, in this sense, tree-structured overlays by the present invention are stronger in stabilizibility than ring-structured overlays in the current P2P SIP systems.

### BRIEF SUMMARY OF THE INVENTION

It is therefore an object of the present invention to provide a system and methods for implementing P2P databases with a balanced-tree distributed overlay structure.

It is another object of the present invention to provide a data structure for storing data and associated keys in individual overlay nodes, along with overlay protocols to maintain database inherency, and to store and retrieve data in overlay distributed databases.

It is yet another object of the present invention to minimize the communication overheads to retrieve data, and to minimize storage and computing overheads for each node, in a tree-structured distributed database.

It is yet another object of the present invention to minimize the impacts from uncertainties and dynamics inherent in overlay networks.

The present invention also provides specifications on protocols to insert a new overlay node, add a new user, to add (register) a new user, to add a store a new data item, to maintain and update the tree-structured overlay.

In order to provide smooth operations, a special class of overlay nodes called grasskeepers are separate out to serve the function of gate keepers for an overlay. They are used as default gate to connect to an overlay. As they serve critical functions, they are chosen based on more selective criteria. To do this, ratings on overlay nodes are kept which provide a historical basis for evaluating the suitability of a node to serve as a gate keeper.

In order to speed up retrieval time, a special algorithm called lamptrack is introduced. With this algorithm, each node keep tracks of the key ranges of a neighboring set of overlay nodes and when an inquiry is received, these key ranges will be used first for searching before a new search initiated to go to other nodes.

A simple analysis by the present invention shows that an optimal balanced-tree is a balanced binary tree; further, two properties have been found to keep a tree in an optimal configuration: inclusion and convexity. These two conditions have been incorporated into the tree-maintenance and update protocols of the present invention.

As overlay nodes can detach from and re-attach to an overlay in an unpredictable manner, the present invention also comes with self-healing and load-balancing algorithms and protocols to keep distributed overlay databases in optimal operational conditions.

### BRIEF DESCRIPTION OF THE DRAWINGS

The above and other objects and features in accordance with the present invention will become apparent from the following descriptions of embodiments in conjunction with the accompanying drawings, and in which:

FIG. 1 shows characterization of an overlay node;

FIG. 2 shows the construction of a grasshoc tree part I;

FIG. 3 shows the further construction of a grasshoc tree part II;

FIG. 4 demonstrates the Lamptrack algorithm;

FIG. 5 demonstrates the self-healing algorithm part I;

FIG. 6 illustrates the self-healing algorithm part II;

FIG. 7 shows a cut of size 3.

### DETAILED DESCRIPTION OF EXEMPLARY EMBODIMENTS

The technical problem that the present invention deals with can be described as follows. In an abstract world with an arbitrary number of users and an arbitrary number of overlay nodes, an overlay database system is to store a given set of data items in a given set of overlay nodes. Each data item or user is identified by a key. Each data item is stored in an overlay node with its associated key. A key (with its associated data) that is stored in a particular node is said to be registered at that node. All keys are assumed to be unique for the present invention. A main function of the distributed overlay database is that, given an arbitrary key K, a user finds a node that stores key K in a finite number of communication steps. Furthermore, overlay protocols should be robust to combat the fact that overlay nodes can disappear and reappear at unspecified times. A key is assumed to be an integer.

A special case of the above abstract problem is VoIP call setup and tear-down using SIP (session initiation protocol) as the telephony control protocol; keys are SIP identifiers.

Hereafter, an overlay protocol by the present invention will all be referred to as a grasshoc protocol. According to one aspect of the present invention, overlay nodes are linked together in the topology of a tree, or a connected directed graph without cycles. Trees constructed in accordance with the present invention will be referred to as grasshoc trees.

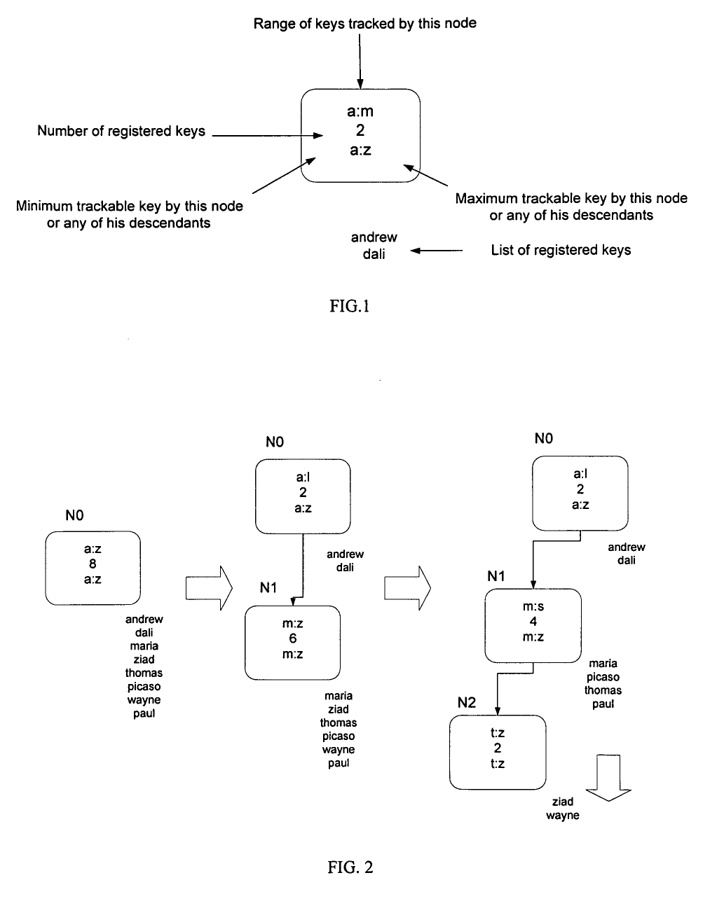

According to many embodiments, as illustrated in FIG. 1, each node in a grasshoc tree keeps track of the following data:
(1) The range of keys that can be registered (or stored) in the node. This range will be referred to as the range of the node.
(2) The minimum and maximum keys that the node or any of its descendant nodes can register. This range (minimum and maximum keys) will be referred to as the sub-tree range of the node.
(3) The keys stored at the node.

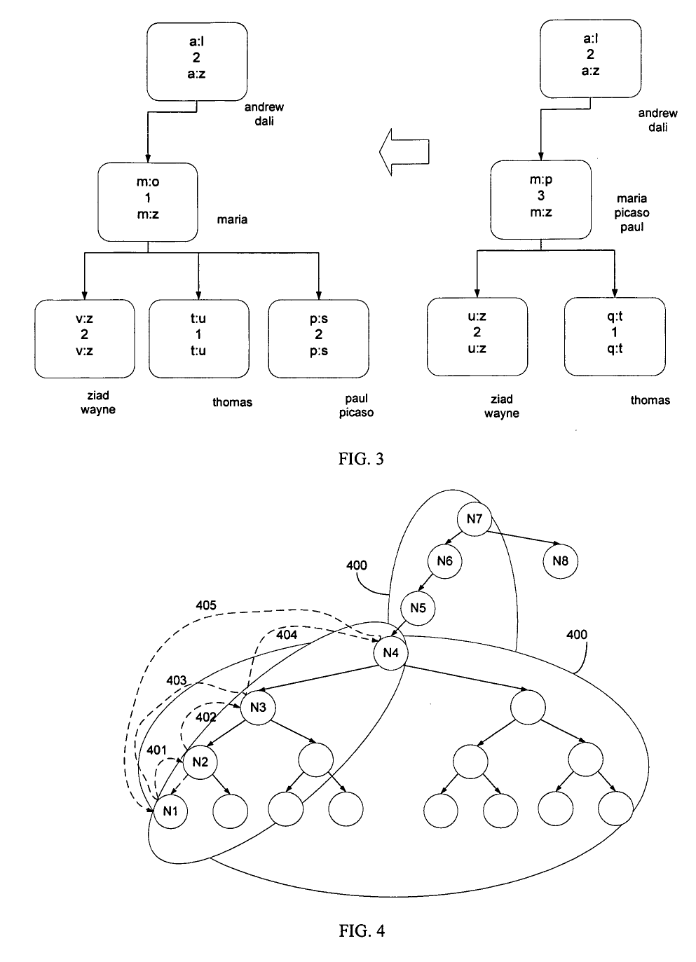

According to an embodiment, the construction of a grasshoc tree can be illustrated by an example; this example is illustrated in FIGS. 2 and 3. Assume there exist 8 data items with the keys: andrew, dali, maria, wayne, ziad, thomas, paul, and picaso. In the beginning, only one node N0 exists in the grasshoc tree and all data items register to that node. Notice that this particular situation—the case of a grasshoc tree with one single node—is equivalent to the centralized database solution. This is illustrated in the left most part of FIG. 2.

When a new node N1 decides to join the tree, it issues an adherence request to node N0. Node N0 then adopts N1 as a child node and assigns a subset of its range of keys to it. In this example, N1 is assigned the range of keys from m to z, while node N0 keeps track of the rest, i.e. from a to m. This is illustrated in the central part of FIG. 2.

Suppose that a new node N2 decides to join the tree. The same identical process executed for node N1 is repeated. In this case, it is decided that node N2 should become a child of node N1 rather than node N0, perhaps because node N1 is handling more data than N0. The outcome is that N2 takes the range of keys going from t to z and leaves the rest of keys (from m to s) to node N1. Therefore, wayne and ziad are re-registered to node N2 and maria, thomas, paul and picaso are kept registered at node N1. This is illustrated in the right most part of FIG. 2.

While FIG. 2 shows the construction of a grasshoc tree part I, part II is depicted in FIG. 3. In the right part (relative to the arrow) of FIG. 3, a new node joins the tree as a descendant of N1, causing N1 to be a parent of two children. In the left part of FIG. 3, yet another node joins N1 as a descendant, causing N1 to be a parent of 3 children.

As illustrated in FIG. 2 and FIG. 3, 4 nodes join the tree. At every transition, a tentative decision is made to offload the work of that node which is most heavily loaded, so that the grasshoc tree grows in a healthy and balanced way.

Once a grasshoc tree is built, an efficient method to find registered data is needed. The process of finding data in a grasshoc tree is referred to as the retrieval protocol of the grasshoc tree.

The following two properties are useful for describing retrieval protocols. Inclusion Property: A grasshoc tree is said to be inclusive if, for any node N in the grasshoc tree, for any key K that belongs to the sub-tree range of a node N, K also belongs to the range of a node which is either a descendant node of node N or node N itself. Convexity Property: A grasshoc tree is said to be convex if, for any node N in the tree, the sub-tree range of node N is equal to the union of the ranges of node N and all its descendant nodes.

According to an embodiment, retrieval protocols are constructed based so that at any point in time, the tree is both inclusive and convex. For example, a retrieval protocol is constructed based on the following outline of codes:

To find a key K, begin at an arbitrary node N in the tree;
If K is in the range of N, then the data item resides in node N;
Otherwise if K is in the sub-tree range of N, then proceed to the child node so that K is in the sub-tree range or the range of that node;
Otherwise, proceed to the parent node;
Repeat the process.

According to one aspect of the present invention, as long as a grasshoc tree is roughly balanced, the number of communications steps is O(log NN), or in the order of the logarithm of NN, wherein NN is the number of nodes in the overlay tree. Therefore, even in the case wherein NN is very large, the number of communications steps to retrieve a data item is practically independent of total number of nodes.

According to an embodiment of the present invention, a special class of nodes called grasskeepers is separated out from the entirety of the nodes in the overlay tree. Grasskeepers are those nodes that, in addition to the tasks they must perform as regular nodes, they also serve as doors of access to the tree. For instance, when a user wants to register a data item (with a key) to the system, it must first contact an initial node in the grasshoc tree and send to it a registration request. Grasskeepers are also those initial nodes used by users and potential (yet to be) overlay nodes to establish a first contact with a grasshoc tree. An arbitrary node in the system will most likely only need to use a particular grasskeeper once or just a few times in its entire lifespan.

According to an embodiment, because of the higher responsibility bestowed on the grasskeepers, not all nodes qualify as grasskeepers. For instance, nodes that tend to be disconnected frequently are not suitable to perform the duties of a grasskeeper. This leads to the notion of quality rating.

A quality rating system is implemented for all the overlay nodes as follows. Each node in the system is given quality ratings which depend on its historical behaviors. Rating metrics are used to determine which tasks each overlay node is most suitable to perform. For instance, nodes that have the highest stability rating are assigned higher responsibility tasks such as those of a grasskeeper; whereas nodes with a lower stability rating simply perform the tasks of a SIP server.

According to an embodiment, quality ratings of a node depend on its historical behaviors. There exists a variety of behaviors that can help improve a node's quality ratings, for instance:
Stability: the longer a node has shown to work without interruption, the higher is the stability rating of that node. Operational consistency is one of the most welcomed behaviors in a grasshoc system. The longer the time a node runs without interruptions, the more stable is the node. Stability is critical in nodes taking higher responsibility tasks such as grasskeepers.
Performance: nodes with higher performance levels should be assigned a higher performance rating. Higher performance rating nodes are those nodes better suited to serve as bottleneck nodes in the system. A bottleneck node is defined to be one that performs tasks that regular nodes cannot perform; therefore, a bottleneck node tends to accumulate more workload than regular nodes.

Since a grasshoc system is fully distributed, an important issue that must be addressed is the question of which entities track the quality ratings of overlay nodes. According to an embodiment, assuming there are no rogue overlay nodes and rogue users, then each overlay node is allowed to track its own quality ratings based on its historical behaviors. Further, overlay nodes are allowed to manage their own status depending on their own quality ratings. For instance, upon exceeding a certain quality rating threshold, a node would upgrade itself to the category of grasskeeper. However, in an adversarial environment, each overlay node is not allowed calculate its own ratings.

According to an embodiment, an adherence (attachment) procedure is executed to allow a new node to join (attach to) the grasshoc overlay. An adherence procedure in the grasshoc protocols is implemented as follows.
(1) Request: The new node N1 sends an adherence request message to an arbitrary grasskeeper node N2 in the tree.
(2) Search: N2 initiates a search in the tree to find a bottleneck node. The definition of bottleneck can vary depending on implementation. A typical definition is “the node with a large number of registered keys”. Yet another implementation can make use of hash functions to determine the bottleneck node.
(3) Adherence: Once a bottleneck node is found, the new node attaches to the tree as a child of the bottleneck node.
(4) Re-registration: Once a new node is attached, a sub-tree range of the keys handled by its parent (the bottleneck node) is updated.

The re-registration process in the embodiments of the present invention should be understood to be different from the SIP server registration. For SIP applications, a user has to register with a SIP server. If the SIP server changes, then the all registered users must re-register. In most embodiments of the present invention, SIP server information is stored as part of the data items. The re-registration process by the present invention (step (4) above) strictly refers to the transfer of stored keys (with data items) between overlay nodes. In case there is a new SIP registration for a user, then the data item associated with its SIP identifier (the key) will have be modified by the request of the user at the overlay node that stores the key.

Racing condition note: there exists a racing condition between the time a node joins the tree and the time data (with keys) from a parent to a child (re-registration) is completely transferred; therefore, it is possible for the tree to violate the properties of inclusion and convexity for a short period of time. According to an embodiment, one way to resolve this racing condition is to perform soft handovers. This will allow keys to be registered at two nodes for a short period of time. Another way is not to do anything. The worst that can happen in this case is the failure of a key search, but this situation is only transient and very short-lived; therefore, a simple retry of a failed search will be successful.

According to an embodiment, in order to avoid ping-pong effects—the effect by which a node is attached and detached to the overlay repeatedly causing multiple adherence requests—a node is allowed to send an adherence message only after a certain amount of minutes has passed since it last attached.

While adherence requests are initiated by new overlay nodes, new registration requests are initiated by users. According to an embodiment, the new registration works as follows:
(1) Request. A new user U sends a registration request message passing along his key K to an arbitrary grasskeeper node N1 in the tree.
(2) Search. Node N1 initiates a search in the tree to find the node N2 that handles the range of keys that includes key K.
(3) Register. Once the search is successful, the user registers his key (with data) to the newly found node N2.

According to most embodiments, the functions of overlay nodes and user can coexist in the same physical device. When both the overlay node and user reside in the same physical device, a grasskeeper for the user is trivially the overlay node residing in its physical device.

Both overlay nodes and users (in the form of client in the case of SIP-based applications) must have a way to attach to the grasshoc tree the first time they boot. According to an embodiment, each node or client comes pre-configured with a list of N default grasskeepers that are pre-configured to be part of the tree. At booting time, each grasskeeper node in the pre-configured list is tried until one of them successfully replies and provides access to the grasshoc tree.

According to an embodiment, to keep the access to the grasshoc tree easy, periodically, a new updated list of grasskeepers is provided to each overlay node and user (client). As an implementation example, this could be done every time an overlay node or a user (client) adheres or registers to the tree.

According to one aspect of the present invention, a fast retrieval protocol, called a lamptrack algorithm is used to minimize the communications steps needed to locate keys.

The lamptrack algorithm is an enhancement that reduces the time required to search a node in a grasshoc tree. To reduce the search time, the lamptrack algorithm trades propagation delay (millisecond range) for CPU cycles (nanosecond range) and memory in each node.

The algorithm works as follows. Each node locally tracks up to D levels of its descendants, as well as up to D levels of its predecessors. Notice that the graph of tracked nodes resembles a lamp, as shown in FIG. 6. The lamp also reflects the notion that a node only knows about that part of the tree on which the lamp can shed some light, while the rest of the tree is in the dark. The depth of the lamp is defined as D, i.e. the number of downward or upward levels that the lamp tracks. When an inquiry for a key is to be served, the protocol exploits the locally available partial knowledge of the overlay network—within the lamp boundaries—and initiates a new communications step to another overlay node to continue the search only when the search falls within the lamp boundaries.

According to an embodiment, the lamptrack algorithm is illustrated in FIG. 4. The following summarizes the steps to create/update the lamps of each node affected by the adherence of a new node in the grasshoc tree. This example assumes a lamp depth of D=3.
Step 0: Node N1 joins the grasshoc tree and creates a lamp including itself and its parent node N2.
Step 1: Node N1 sends an UPDATE_LAMP to its parent node N2; node N2 updates its lamp to include node N1, as indicated in the dotted arrow 401.
Step 2: Node N2 sends an UPDATE_LAMP to its parent node N3; node N3 updates its lamp to include node N1, as indicated in the dotted arrow 402.
Step 3: Node N3 sends an UPDATE_LAMP to node N1; node N1 updates its lamp to include node N3, as indicated in the dotted arrow 403.
Step 4: Node N3 sends an UPDATE_LAMP to its parent node N4; node N4 updates its lamp to include node N1, as indicated in the dotted arrow 404.
Step 5: Node N4 sends an UPDATE_LAMP to node N1; node N1 updates its lamp to include node N4, as indicated in the dotted arrow 405.

To understand how retrievals can be sped up, suppose that in FIG. 6 node N1 wants to find a key that is registered in node N8. Without the lamptrack algorithm, the route followed from N1 to N8 is the following:

N1=>N2=>N3=>N4=>N5=>N6=>N7=>N8.

Therefore, it takes 7 hops to in the search to find the desired node. If instead a lamptrack algorithm of depth D=3 is implemented, node N1 can internally calculate the route up to node N4, and node N4 can calculate the route up to node N7, which is just one hop away from the final destination. The upstream and downstream lamps 400 of N4 are indicated in FIG. 4 as illustration. The route followed using the lamptrack algorithm is hence the following:

N1=>N4=>N7=>N8;

i.e., only 3 hops are needed.

To provide security measures for grasshoc protocols, according to an embodiment, authentication is required for all overlay nodes and users. Each node or user is equipped with a secret key that changes periodically. This will protect against fake attachment and detachment to the grasshoc tree.

According to another aspect of the present invention, a grasshoc protocol is also used to make a grasshoc tree self-healing. By its nature, a grasshoc tree is made of nodes that can appear and disappear unpredictably. As such, mechanisms to ensure the overall correctness of the protocol even when nodes suddenly disappear must be employed.

The self-healing scenario that must be addressed is simple to understand. Suppose a node N in the grasshoc tree disappears all of a sudden. Two problems arise:
(1) The users registered to node N will be disconnected from the system;
(2) The sub-tree made up of node N's descendants will be disconnected from the rest of the grasshoc tree.

The above situation will be referred to as a cut. To resolve a cut, an algorithm must be implemented thereby the nodes in the tree that are still well-functioning can repair (heal) the cut. Two functions need to be implemented: detection and repair of cuts.

According to an embodiment, to detect a cut in a distributed way, each grassnode is given the task to monitor the state of each of its children. Periodically, each overlay node will broadcast a KEEP_ALIVE message to its children, who in turn will respond with a KEEP_ALIVE_OK message. If a child does not return a KEEP_ALIVE_OK message, then its parent node will assume the child has left the system.

The repair operation assumes that each node has certain knowledge about its descendants, up to a certain number of levels. If the lamptrack algorithm is in place, then the knowledge of the lamp can be used to repair a cut. If no lamptrack algorithm is being run, then a mechanism to track up to multiple levels of descendant nodes must be implemented just for the purpose of repairing cuts.

According to an embodiment, a lamptrack algorithm of depth D is implemented. Notice that in this case, each node tracks up to D levels of descendants. Assume that node N detects a cut in one of its children; call it node N1. To repair the cut, node N will solicit a leaf node N2 in the grasshoc tree to replace node N1. Node N2 will then ask its own parent node to take care of its key range and immediately proceed to take on the mission of replacing node N1. When soliciting node N2 to replace node N1, node N has to pass along enough information so that node N2 can successfully perform the replacement operation. In particular, it has to pass information about (1) who the new children of node N2 are (i.e. node N1's children) (2) who its new parent is (i.e. node N) and (3) the new range of keys that node N2 will need to take care of (i.e. node N1's range of keys). Notice that the information about node N1's children is contained in node N's lamp as long as D>1.

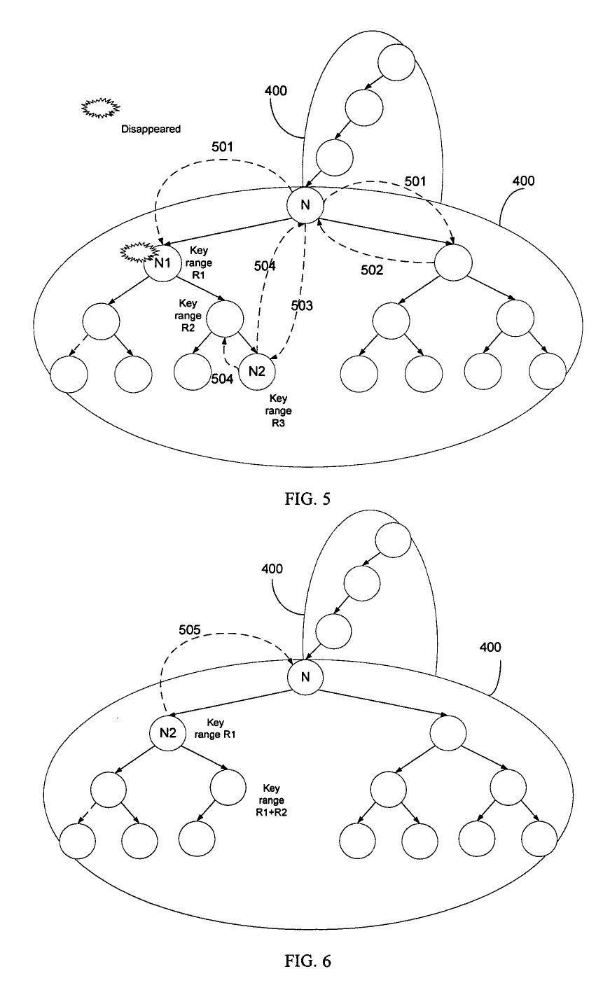

FIGS. 5 and 6 present an example with each step of the self-healing algorithm being detailed below.
Step 1: Node N broadcast a KEEP_ALIVE message 501 to each of its children.
Step 2: One of the node replies with a KEEP_ALIVE_OK message 502, but the other child (i.e. node N1) does not reply. After a timeout, node N concludes that node N1 has disappeared and a cut is detected.
Step 3: Node N solicits (503) node N2 (which must be a leaf in the grasshoc tree) to replace node N1. Node N sends along node N2 the following information: (1) who the children of node N1 are, (2) what is the key range of node N1 (i.e. key range R1) and (3) who will be the new parent of node N2 (i.e. node N).
Step 4: Node N2 acknowledges (504) the petition from node N and informs (504) its parent node to take care of its range of keys R3. The parent node will therefore take care of its current key range (R2) plus key range R3.
Step 5: Node N2 configures itself to perform the same tasks as node N1 and it acknowledges (505) node N about the completion of the self-healing procedure. The upstream and downstream lamps 400 of N are also indicated in FIG. 5 and FIG. 6.

The above procedure works as long as each node keeps track of at least 2 levels of descendants (e.g. by way of a lamp of depth 2 or larger). But cut events can occur in bursts and therefore they can take different forms and sizes. To understand the implications of this point in more detail, the concept of the size of a cut is needed.

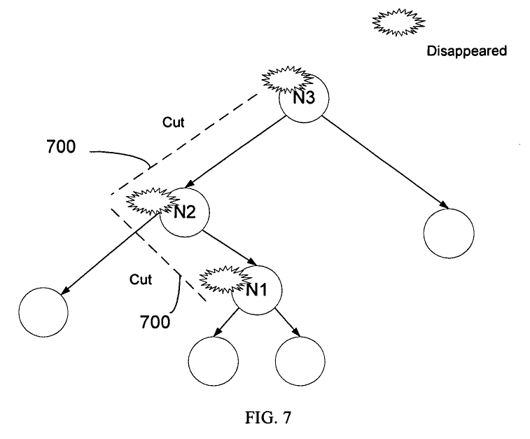

The size of a cut is defined as the maximum number of consecutive descendants that have disappeared at the time a cut is detected. A cut 700 of size 3 is illustrated in FIG. 7.

The following observations can be made. Nodes with lamps of depth D can resolve cuts of size D-1 or smaller. The larger D is, the larger cuts a grasshoc system can resolve and therefore the larger the probability of surviving a cut. In general, the probability of surviving a cut is a well-defined measure intrinsic of each grasshoc tree and which depends on parameters such as the tree topology and the size of each lamp. More specifically, given a grasshoc tree topology and the depth of the lamptrack algorithm, one can always calculate the probability of surviving a cut.

Assume that a grasshoc topology is such that each node has a fixed number of children equal to M. Then, the probability of not surviving a cut of size can be mathematically derived as a function of M. This mathematical result can be used to find the optimal number of children per node that minimizes the probability of not surviving a cut. It can be proven that the optimal number of children per node is two, i.e., M=2.

Therefore, according to an embodiment, the number of descendants per overlay node should be two; and the grasshoc protocol always attempts to construct and maintain the grasshoc tree as a balanced binary tree. This approach is proven to maximize the probability of surviving cuts.

According to an embodiment, grasshoc trees must be structured as close as possible to the structure of ideally balanced binary trees. In addition, to maximize efficiency, the workload of each overlay node should be balanced so that no node becomes comparatively too overloaded. For instance, if a node N1 is comparatively less loaded than node N2, then a mechanism should be in place to shift workloads from node N2 to node N1 (directly or indirectly). A grasshoc tree is said to be well-balanced when all nodes are comparatively even loaded. The operation of shifting loads between nodes in order to have all nodes similarly loaded is referred to as balancing a tree.

According to an embodiment, the following balancing algorithm is implemented in the grasshoc protocol. This algorithm is invoked at the time a new node adheres the grasshoc tree. It works as follows:

(1) If node N1 makes an adherence request, then a random set of nodes in the grasshoc tree is measured for their workloads. Let node N2 be the node with the largest workload among the randomly selected nodes.

(2) If node N2 can accept more children, then node N1 will be adhered as a child of node N2, taking over some of its workload.

(3) Otherwise, if node N2 cannot accept any more children, then part of node N2's workload is successively passed to its descendants, until a descendant that can accept a child is found. Let node N3 be this node, then node N1 will adhere as a child of node N3.

In step (3) above, the passing of workload from one node to another must be done in a way that the fundamental properties of the grasshoc tree are preserved, that is to say, at the end of step (3) the tree must continue to be inclusive and convex. In an actual implementation, the workload passed is specified in terms of a key range: node N2 passes a subset of its current key range to a child and in turn this child forwards this key range to one of its own child, repeating this process until a node that can accept new children is found.

According to yet another embodiment, an alternative way to load-balance a grasshoc tree is through a hash function. In this approach, each overlay node is given a unique ID that is transformed into an integer value using a consistent hash function such as SHA-1 (consistent in the sense that keys obtained from the hash function are uniformly distributed). This integer is referred to as the key of the node. When joining the tree, a node N1 first calculates its key. Such key will fall into one of the existing node's range (the range of a node is a range of integers), call it node N2. Then, node N1 will be responsible to offload the registered keys from node N2. In particular, node N1 will take upon the responsibility of managing the keys contained in the semi-half segment delimited by the range limits of node N2.

What is claimed is:

1. A method to implement distributed databases hosted over a P2P tree-structured overlay, comprising:
a plurality of nodes called grassnodes or simply nodes, forming a P2P overlay;
a plurality of users, each with a unique key;
a plurality of data items, each with a unique key;
and a set of distributed overlay protocols called grasshoc protocols;
wherein each said grassnode is connected to other grassnodes through an IP network; each said grassnode may be associated with a finite number of child grassnodes and a single parent grassnode, thus the entirety of said grassnodes forming approximately a balanced-tree called a grasshoc tree or simply tree; each said grassnode may be repeatedly attached to and detached from said overlay unpredictably; and said grasshoc protocol enables said grassnodes to locate the IP address of a grassnode needed for storing, retrieval and other control mechanisms, for the purpose of implementing said distributed databases.

2. The method of claim 1, wherein each said grassnode keeps track of: (a) the range of keys that can be registered (or stored) in the said node; (b) the minimum and maximum keys that the said node or any of its descendant nodes can register, or the sub-tree range of the said node; (c) the keys stored at the said node.

3. The method of claim 2, wherein said grasshoc tree is approximately a binary balanced-tree.

4. The method of claim 3, wherein a said grasshoc protocol maintains and updates a grasshoc tree so that it is both inclusive and convex in its lifespan; a grasshoc tree is said to be inclusive if, for any node N in the grasshoc tree, for any key K that belongs to the sub-tree range of a node N, K also belongs to the range of a node which is either a descendant node of node N or node N itself; a grasshoc tree is said to be convex if, for any node N in the tree, the sub-tree range of node N is equal to the union of the ranges of node N and all its descendant nodes.

5. The method of claim 4, wherein a special class of said grassnodes called grasskeepers is separated out to perform additional duties so that: (a) a said user must first contact a grasskeeper in order to register a new data item to a said database; (b) a detached said grassnode must first contact a grasskeeper for it to be joined to said grasshoc tree; (c) a new said user must first contact a grasskeeper to initiate a contact with said grasshoc tree.

6. The method of claim 5, wherein an adherence procedure in said grasshoc protocols is implemented as follows: (a) a new said node N1 sends an adherence request message to an arbitrary grasskeeper node N2 in said tree; (b) N2 initiates a search in said tree to find a random said grassnode, or a said grassnode with a larger number of registered keys; then the new said node attaches to said tree as a child of the found said grassnode; (c) once a new said node is attached, the sub-tree range of the keys handled by its parent is updated.

7. The method of claim 6, wherein a registration procedure for a new said user is implemented as follows: (a) a new said user U sends a registration request message passing along his key K to an arbitrary grasskeeper node N1 in the tree; (b) node N1 initiates a search in said tree to find the node N2 that handles the range of keys that includes key K; (c) once the search is successful, said new user registers his key (with data) to the newly found node N2.

8. The method of claim 7, wherein a lamptrack algorithm is implemented in each said grassnode as follows: (a) each said grassnode locally stores the ranges of keys stored in its descendant and parent grassnodes up to D levels up and D levels down said grasshoc tree; (b) whenever a said grassnode changes its range of stored keys, this change is communicated to every said grassnode that stores its key range; (c) if an inquiry for a key is received at a said grassnode, a local search for such key is first conducted in the ranges of keys stored in the said grassnode before a new inquiry to another said grassnode is initiated.

9. The method of claim 8, wherein detection of cuts in a grasshoc tree is implemented as follows: (a) each said grassnode node is given the task to monitor the state of each of its children; (b) periodically, each grassnode node broadcasts a KEEP_ALIVE message to its children, who in turn will respond with a KEEP-ALIVE_OK message; (c) if a child does not return a KEEP_ALIVE_OK message within a time limit, then its parent grassnode decides the said child has left said overlay.

10. The method of claim 9, wherein repair of cuts in a grasshoc tree is implemented as follows: (a) each said grassnode deploys a lamptrack algorithm of depth D; (b) if a said grassnode N detects a cut in one of its children, say N1, then node N solicits a leaf grassnode N2 in said grasshoc tree to replace N1; (c) N2 then asks its own parent grassnode to take care of its key range and proceeds to replace node N1.

11. The method of claim 10, wherein a load-balancing algorithm is added as follows: (a) if a said grassnode N1 makes an adherence request, then a random set of grassnodes in the grasshoc tree is measured for their workloads; (b) choose or elect among said random set of nodes a node called N2 with largest workload; (c) if N2 can accept more children, then node N1 will be adhered as a child of node N2; (c) otherwise, a part of node N2's workload is successively passed to its descendants, until a descendant called N3 that can accept a child is found; then node N1 will adhere as a child of node N3.

12. A method of claim 5 wherein a said node is allowed to send an adherence message only after a certain amount of minutes has passed since it last attached.

13. A method of claim 5 wherein a list of valid grasskeeper nodes is broadcast to all grassnode periodically.

14. A computer-readable medium with a computer program for performing the method as described in any one of claims 1 to 13.
